(19) United States
(12) Patent Application Publication
(10) Pub. No.: US 2005/0256624 A1
(43) Pub. Date: Nov. 17, 2005

(54) Slope driving mode for vehicles with automatic transmission

(76) Inventors: Peter Sporl, Ravensburg (DE); Oliver Iden, Weissensberg (DE); Patrick Speicher, Oberteuringen (DE); Andreas Rodler, Langenargen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/127,959

(22) Filed: May 12, 2005

(30) Foreign Application Priority Data
May 15, 2004 (DE) 10 2004 024 318.2

(51) Int. Cl. G06F 19/00

(52) U.S. Cl. 701/65; 701/51

(57) ABSTRACT

Within the framework of the method for recognizing a downhill descent and for operating the transmission of a motor vehicle in a downhill descent mode during a downhill descent for a motor vehicle that has a continuously variable transmission (CVT), an automatic transmission or an automated manual shift transmission a downhill descent is recognized if in coasting operation there is an increase in speed, whereby in the downhill descent mode, a downhill descent signal indicating a downhill descent is formed in coasting operation and is used by the driving strategy unit for calculating a target gear ratio for the transmission control unit.

The present invention concerns a method for recognizing a downhill descent and for operating a transmission in a downhill descent mode during a downhill descent for a motor vehicle, which has a continuously variable transmission (CVT), an automatic transmission or an automated manual shifting transmission in accordance with the preamble to patent claim 1.

The recognition of a downhill descent is of particular significance in motor vehicles which have a continuously variable transmission (CVT) since the internal combustion engine is often operated at low rotational speeds, which results in a low motor braking effect in coasting operation.

A system for adjusting the gear ratio of a transmission that is continuously variable in its gear ratio positioned downstream in series from a motor vehicle engine is known from DE 196 10 950 A1. Here a downhill descent is recorded and the adjustment of the gear ratio of the transmission is activated as a function of the downhill descent recorded. Resources are provided in accordance with DE 196 10 950 A1 by way of which the gear reduction adjustment is activated in reaction to a recorded downhill descent such that the transmission input and/or motor rotational speed rises in a specific manner. This way it is ensured that the transition from normal operation (no downhill descent) to the downhill descent function at first takes place unnoticed by the driver since the motor rotational speed does not rise unexpectedly for the driver. The increase in transmission input and/or motor rotational speed takes place with a specified gradient, which is dependent upon the parameters present when the downhill descent is recorded.

Furthermore, a method for operating a motor vehicle with a continuously variable transmission is known from DE 43 30 391 A1 in which the driving state of a downhill descent is ascertained, recorded and stored at the time of the beginning of the downhill descent. The transmission is then continuously adjusted such that the ascertained speed is basically maintained using the motor braking action.

Here ascertaining the downhill descent and the motor vehicle speed can take place by recording certain operating parameters, whereby corresponding sensors are used for ascertaining the operating parameters. In the case of a braking operation, a continuous adjustment of the transmission altering, especially increasing, the gear ratio is conducted to support the braking of the motor vehicle. Moreover, recognition of downhill descent during the downhill descent motor braking operation is provided by the conditions; throttle valve angle is minimal, especially zero, longitudinal acceleration of the motor vehicle is positive.

Storing the motor vehicle speed recorded at the beginning of downhill descent as a target speed and comparing this target speed with the momentary vehicle speed during the downhill descent is moreover known from DE 43 30 391 A1, whereby a new target speed is established if the deviation between the target speed and the momentary motor vehicle speed exceeds a specifiable threshold.

The present invention is based upon the objective of indicating a method for recognizing a downhill descent and for operating the transmission of a motor vehicle in downhill descent mode during a downhill descent for a motor vehicle comprising a continuously variable transmission (CVT), an automatic transmission or an automated manual shifting transmission that takes the driver's wishes into consideration during the downhill descent and enables a recognition of a downhill descent in a simple and secure manner.

This objective is realized by the features of patent claim 1. Further refinements and advantages in accordance with the invention emerge from the dependent claims.

Accordingly a method for recognizing a downhill descent and for operating the transmission of a motor vehicle during a downhill descent (downhill descent mode) is proposed in the framework of which a downhill descent signal, indicating a downhill descent, is formed in downhill descent mode in coasting operation and is forwarded to the drive strategy unit for calculating a target gear ratio for the transmission control. The variator can be appropriately adjusted with a CVT transmission. Shifting into an appropriate gear takes place with an automatic transmission or an automated manual shift transmission. A downhill descent is recognized when an increase in speed exists in coasting operation.

The downhill descent signal is formed in accordance with the invention in the coasting operation by the continuous summation of the speed differences or the increases in speed between the current point in time and the time the downhill descent is recognized. For example, the following formula can be used for calculating the downhill descent signal:

$$ba\_sig = {\sum }_{i = 0}^{n} ( {v}_{i + 1} - {v}_{i} ) ,$$

whereby v₀ is the speed at the time the downhill descent is recognized, n is the number of discrete time intervals between the current point in time and the time of recognition of the downhill descent and vₙ₊₁ is the current speed of the motor vehicle.

The downhill descent signal, formed in this way, is modulated in accordance with an advantageous further development of the invention as a function of the braking activity, the activation of the speed regulating facility and the accelerator value and/or is multiplied or incremented or decremented with a modulation factor k_ba_sig. Subsequently, it is forwarded to the drive strategy unit for calculation of a target gear reduction for the transmission control. The modulation factor k_ba_sig is taken into consideration here using the formula:

$$ba\_sig = {\sum }_{i = 0}^{n} ( ( {v}_{i + 1} - {v}_{i} ) * k\_ba {\_sig}_{i + 1} ) ,$$

It is provided in accordance with the invention that the downhill descent mode is activated when the motor vehicle is operated in coasting operation, that is, when there is no torque demand on the part of the driver. It is proposed in the framework of a further development that the downhill descent mode be deactivated and remain in this state if an existing converter clutch is opened and it has been established that the downhill descent mode can only be activated when the converter clutch is closed. The reason for this lies in the fact that when the converter clutch is open an increase in speed, for example on the primary disk of the variator, does not result in an increase in the rotational speed of the motor and consequently in an increased braking action.

The invention is explained in greater detail on the basis of the appended figures, wherein:

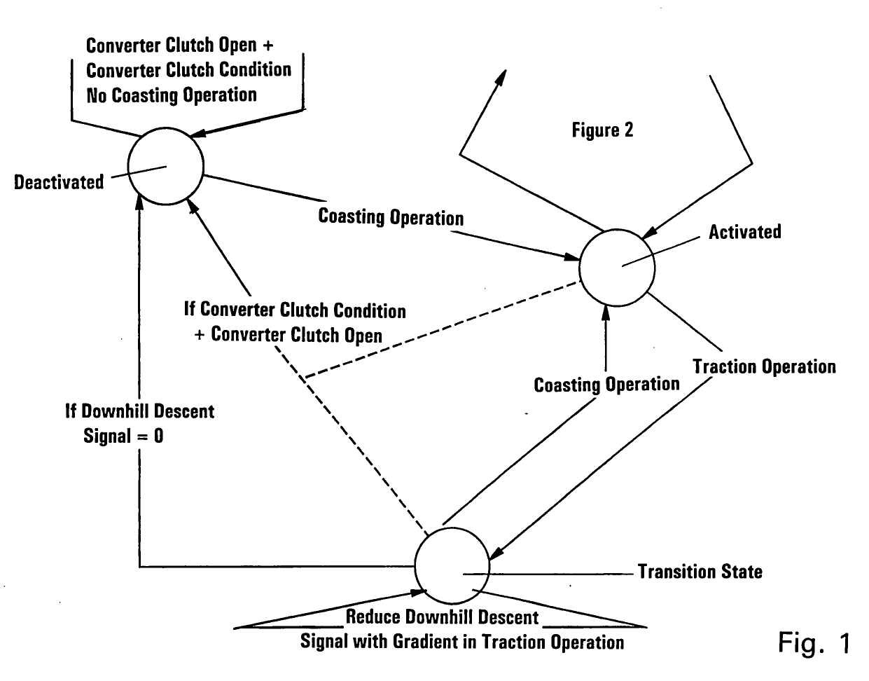

FIG. 1 represents a flow diagram, which illustrates the various states of the downhill descent mode;

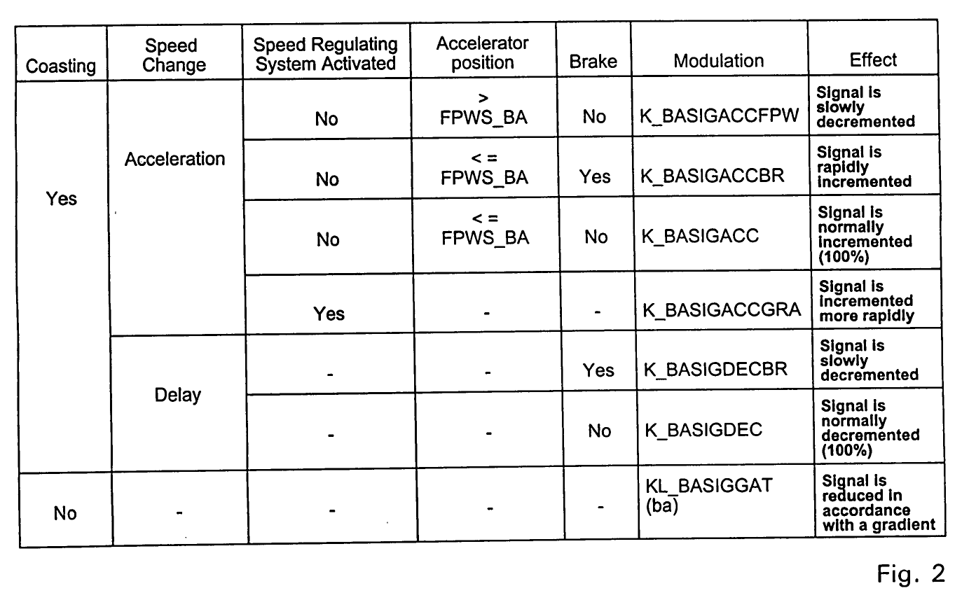

FIG. 2 represents a table which illustrates the various options for forming a downhill descent signal as function of the parameters considered in the framework of the method in the activated downhill descent mode; and

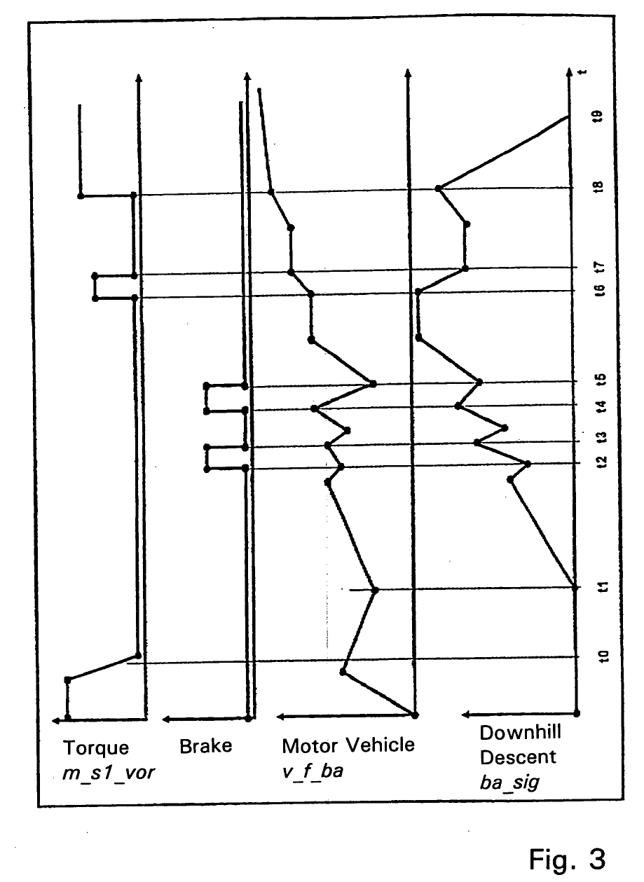

FIG. 3 represents a diagram, which illustrates the connection between the course over time of the downhill descent signal and the course over time of the speed and input torque.

In accordance with FIG. 1, the downhill descent mode includes three states, namely “deactivated,” “activated” and “transition state”. The deactivated mode is maintained until the vehicle passes over into coasting operation. As already described, the deactivated state is not left if an existing converter clutch is open and it has been established that the downhill descent mode can only be activated when the converter clutch is closed (WK condition). In the “deactivated” state, the downhill descent signal has the value of zero. When the converter clutch WK is open in the “activated” mode or in the transition state and it is established that the downhill descent mode can only be activated when the converter clutch is closed (WK condition), there is a transition into the “deactivated” state.

When a coasting operation is recognized, there is a transition into the “activated” state. A coasting operation is recognized in accordance with the invention when the input torque or the motor torque is smaller than a threshold value or when the accelerator position or the throttle valve setting falls below a specified, very low threshold value and, at the same time, a specified time interval is exceeded once the value has dropped below threshold value. The dead times the system needs to react to a torque reduction, for example for comfort reasons, are herewith taken into consideration. A coasting operation can also be recognized in accordance with the invention when the fuel consumption falls below a threshold value.

When there is a transition into the “activated” state, then the current speed of the motor vehicle is regarded as the initial speed for calculating the downhill descent signal.

The downhill descent signal is formed in the “activated” state, which is described in greater detail on the basis of FIG. 2. The “activated” state is left when the coasting operation is left or when the input torque or the motor torque exceeds the specified threshold value. The downhill descent signal is then reduced or decremented to zero in accordance with the invention, preferably using a gradient, and subsequently there is a transition into the “deactivated” state. If a coasting operation is recognized in the transition state, there is a return to the “activated” state.

The difference in speed between the preceding and the current calculation cycle since the recognition of a downhill descent are summated or integrated in accordance with the invention, whereby the difference in speed can be modulated depending upon the driving situation with the factor k_ba_sig in order to ascertain a target gear ratio in this manner that corresponds to the driver's wishes. The determination of the downhill descent signal to be transmitted to the driving strategy unit is the object of the table in FIG. 2.

If the vehicle accelerates in coasting operation, the speed regulation facility is shut off, the accelerator position does not exceed the specified threshold value FPWS_BA and the brake is not activated, the downhill descent signal is forwarded unmodulated to the driving strategy unit. The factor (value is one) is designated with K_BASIGACC in the table.

In the event that the motor vehicle brakes are activated in a coasting operation at an acceleration of the motor vehicle when the speed regulating facility is turned off and with an accelerator position that is smaller than or equal to the specified threshold value FPWS_BA, the downhill descent signal is rapidly incremented or multiplied by a factor greater than one in order to support the braking process. The corresponding factor k_ba_sig is designated as K_BASIGACCBR in the table.

If the motor vehicle accelerates in coasting operation and the speed regulating unit is turned on, the downhill descent signal ba_sig is incremented or multiplied by a factor k_ba_sig, which is designated in the table with K_BASIGACCGRA (K_BASIGACCGRA>1).

Accordingly, the downhill descent signal is slowly decremented in coasting operation and at an acceleration of the motor vehicle (speed increase) when the speed regulating unit is shut off and when the brakes are not activated if the accelerator position exceeds a specified threshold value FPWS_BA (the driver accelerates). The corresponding modulation factor k_ba_sig is designated as K_BASIGACCFPW and is smaller than zero.

The downhill descent signal is decremented or multiplied by a corresponding factor K_BASIGDECBR when the motor vehicle speed in coasting operation diminishes and the brake is activated. In this case, if the brake is not activated, the downhill descent signal is forwarded unmodulated to the driving strategy unit. This factor (value is one) is designated with K_BASIGDEC in the table. In this way whether a delay takes place due to braking or from coasting to a stop at the end of the downhill descent is advantageously distinguished.

In the event that coasting operation is ended, there is a transition into the transition state during which the downhill descent signal is decremented by a time function, for example with a gradient KL_BASIGGAT.

The object of FIG. 3 is the connection between the course of the downhill descent signal over time and the course of the speed and the input torque over time.

The upper diagram represents the course over time of the input torque m_s1_v. The braking activity is represented in the second diagram from above and the corresponding motor vehicle speed v_f_ba is represented in the next to the last diagram. The resulting downhill descent signal ba_sig is represented in the lower diagram. Torque is reduced and speed is correspondingly reduced at time t_0. The downhill descent begins at time t_1 and the speed of the motor vehicle increases so that the downhill descent rises. As is apparent from FIG. 3, the course of the downhill descent is proportional to the course of the speed. That is, the signal increases with increasing speed and drops with decreasing speed.

The motor vehicle accelerates in the time interval t2-t3 despite activated brakes. The build-up of the downhill descent signal here takes place faster due to the modulation factor K_BASIGACCBR. The input torque exceeds the specified threshold value at t_3 and t_4 so that the downhill descent signal is reduced in accordance with a gradient. The speed is diminished in the time interval t_4-t_5 by way of brake activation so that the reduction of the downhill descent signal is slowed down by the modulation factor K_BASIGDECBR. The input torque exceeds the specified threshold value in the time intervals t_6-t_7 and t_8-t_9 so that the downhill descent signal is reduced in accordance with a gradient.

The method of the invention makes it possible to calculate the downhill descent signal even when the brakes are activated. Here the downhill descent signal is increased to support the brake and to improve the action of the brake. Furthermore, fluctuations of a downhill descent can be taken into consideration through the continuous summation of the differences in speed according to the invention.

### REFERENCE NUMBERS

ba_sig downhill descent signal
k_ba_sig modulation factor of the downhill descent signal
FPWS_BA threshold value for the accelerator position
v_f_ba motor vehicle speed
m_s1_vor input torque

1-17. (canceled)

18. A method for recognizing a downhill descent and for operating a transmission of a motor vehicle in a downhill descent mode in the downhill descent for the motor vehicle which has one of a continuously variable transmission (CVT), an automatic transmission or an automated manual shift transmission, the downhill descent is recognized if an increase in speed exists in a coasting operation, a downhill descent signal indicating the downhill descent is formed in the downhill descent mode in coasting operation and is used by a driving strategy unit for calculation of a target gear ratio for a transmission control unit.

19. The method for recognizing the downhill descent and for operating the transmission of the motor vehicle in the downhill descent mode during the downhill descent according to claim 18, wherein the downhill descent signal is formed by continuous summation or integration of speed differences between two successive calculation cycles.

20. The method for recognizing the downhill descent and for operating the transmission of the motor vehicle in the downhill descent mode during the downhill descent according to claim 19, wherein the downhill descent signal ba_sig is formed according to a formula:
$$ba\_sig = {\sum }_{i = 0}^{n} ( {v}_{i + 1} - {v}_{i} ) ,$$
whereby v₀ is a speed at a time of recognition of the downhill descent, n is a number of discrete time intervals between a current point in time and a time of recognizing the downhill descent and vₙ₊₁ is a current speed of the motor vehicle.

21. The method for recognizing the downhill descent and for operating the transmission of the motor vehicle in the downhill descent mode during the downhill descent according to claim 18, wherein the downhill descent signal is formed by one of continuous summation or integration of a difference in speed between two successive calculation cycles modified by a driving situation dependent modulation factor k_ba_sig.

22. The method for recognizing the downhill descent and for operating the transmission of the motor vehicle in the downhill descent mode during the downhill descent according to claim 21, wherein the downhill descent signal ba_sig is formed according to a formula:
$$ba\_sig = {\sum }_{i = 0}^{n} ( ( {v}_{i + 1} - {v}_{i} ) * k\_ba {\_sig}_{i + 1} ) ,$$
whereby v₀ is a speed at a time of recognition of the downhill descent, n is the number of discrete time intervals between the current time and the time of recognition of the downhill descent, vₙ₊₁ is a current speed of the motor vehicle and k_ba_sig is a driving situation-dependent modulation factor.

23. The method for recognizing the downhill descent and for operating the transmission of the motor vehicle in the downhill descent mode during the downhill descent according to claim 21, wherein the driving situation-dependent modulation factor k_ba_sig is determined as a function of the braking activity, activation of the speed regulating system, the accelerator value and further parameters.

24. The method for recognizing the downhill descent and for operating the transmission of the motor vehicle in the downhill descent mode during the downhill descent according to claim 18, wherein the downhill descent mode includes a “deactivated,” “activated” and “transition state” states, the downhill descent mode is activated when the motor vehicle is operated in a coasting operation, the “activated” state is left when the coasting operation is left, such that the downhill descent signal is reduced or decremented to zero and there is subsequently a transition into the “deactivated” state and when the coasting operation is recognized in the transition state, there is a return to the “activated” state.

25. The method for recognizing the downhill descent and for operating the transmission of the motor vehicle in the downhill descent mode during the downhill descent according to claim 24, wherein the downhill descent signal is one of reduced or decremented to zero by means of a gradient upon leaving the “activated” state.

26. The method for recognizing the downhill descent and for operating the transmission of the motor vehicle in the downhill descent mode during the downhill descent according to claim 24, wherein the downhill descent mode is deactivated and remains in the deactivated state if an available converter clutch is open and is established that the downhill descent mode can only be activated when the converter clutch is closed.

27. The method for recognizing the downhill descent and for operating the transmission of the motor vehicle in the downhill descent mode during the downhill descent according to claim 24, wherein the coasting operation is recognized when one of a input torque or a motor torque is smaller than a threshold value or when one of an accelerator position or a throttle valve setting drops below a specified, very low threshold value and at a same time a specified time interval is exceeded after the value has dropped below one of a threshold value or when fuel consumption falls below an other threshold value.

28. The method for recognizing the downhill descent and for operating the transmission of the motor vehicle in the downhill descent mode during the downhill descent according to claim 24 wherein, when there is a transition into the “activated” state, a current speed of the motor vehicle serves as an initial speed for calculating the downhill descent signal.

29. The method for recognizing the downhill descent and for operating the transmission of the motor vehicle in the downhill descent mode during the downhill descent according to claim 24, wherein in an event that the motor vehicle accelerates in the coasting operation when a speed regulation facility is shut off and a brake is not longer activated, the downhill descent signal is slowly decremented if an accelerator position exceeds a specified threshold value, whereby a modulation factor is smaller than zero.

30. The method for recognizing the downhill descent and for operating the transmission of the motor vehicle in the downhill descent mode during the downhill descent according to claim 24, wherein in an event that the motor vehicle accelerates in the coasting operation despite a brake being activated when a speed regulating facility is shut off and with an accelerator position that does not exceed a specified threshold value, the downhill descent signal is rapidly incremented, whereby a modulation factor is greater than one.

31. The method for recognizing the downhill descent and for operating the transmission of the motor vehicle in the downhill descent mode during the downhill descent according to claim 24, wherein in the event that the motor vehicle accelerates in coasting operation when the speed regulating facility is shut off, the accelerator position does not exceed the specified threshold value and the brake is not activated, the downhill descent signal is calculated unmodulated, whereby the modulation factor is one.

32. The method for recognizing the downhill descent and for operating the transmission of the motor vehicle in the downhill descent mode during the downhill descent according to claim 24, wherein in an event that the motor vehicle accelerates in the coasting operation when a speed regulating facility is turned on, the downhill descent signal increments rapidly, whereby a modulation factor is greater than one.

33. The method for recognizing the downhill descent and for operating the transmission of the motor vehicle in the downhill descent mode during the downhill descent according to claim 24 wherein, in an event that the motor vehicle speed declines in the coasting operation and a brake is activated, the downhill descent signal is slowly decremented, whereby a modulation factor is between zero and one.

34. The method for recognizing the downhill descent and for operating the transmission of the motor vehicle in the downhill descent mode during the downhill descent according to claim 22 wherein, in an event that the motor vehicle speed decreases in the coasting operation and a brake is not activated, the downhill descent signal is calculated unmodulated, whereby a modulation factor is one.
